(19) United States
(12) Patent Application Publication
(10) Pub. No.: US 2019/0226646 A1
(43) Pub. Date: Jul. 25, 2019

(54) REMOTELY CONTROLLED ELECTRONIC LIGHTING APPARATUS WITH VARIABLE LIGHT DIRECTION AND FOCUS

(71) Applicant: E.N.R.G Private Capital LTD., Bat Yam (IL)

(72) Inventor: Nir DVASH, Aniam (IL)

(21) Appl. No.: 15/877,492

(22) Filed: Jan. 23, 2018

(51) Int. Cl. F21K 9/238; H05B 33/08; H05B 37/02; F21V 14/02

(52) U.S. Cl. CPC F21K 9/238; F21V 14/02; H05B 37/0272; H05B 33/0845

(57) ABSTRACT

A remotely controlled lighting apparatus, the lighting apparatus including: a housing and an electrical contact, the housing comprising: a light source; a motion unit mechanically coupled to the light source; a control unit electrically coupled to the motion unit and the light source and configured to control the motion unit to direct illumination emanating from the light source; and a translucent envelope enclosing the control unit, the motion unit, the light source.

### FIELD OF THE INVENTION

The present invention relates to a lighting apparatus and, more particularly, to an electronically controlled lighting apparatus such as an LED light bulb where the light from the bulb can be directed, focused and/or the intensity of the light adjusted remotely, either from a control panel or a wireless device such as a dedicated remote control, a smartphone, PC, Smart Speaker, and other IoT devices.

### BACKGROUND OF THE INVENTION

Lighting units with individually movable lamps, motor means configured to adjust the position of said lamps, controlling means configured to transmit drive signals to the motor means in dependence upon received control signals are known in the art. However, such systems relate to regular lamps which are affixed to motion controlled platform.

Since the days of the first incandescent light bulb invented by Edison, there has been only one big revolution in the field which is the LED light bulb, currently taking the place of all other bulbs (incandescent, halogen, compact fluorescent lamp, etc.) in the market. Advances in field of digital, electronic and wireless devices, as well as the development of the IoT market also enabled these bulbs to become ‘smart’ by allowing the user to remotely control and/or schedule the toggling of the ON/OFF state of the lighting apparatuses, as well as change the color and/or intensity thereof.

### SUMMARY OF THE INVENTION

According to the present invention there is provided a remotely controlled lighting apparatus, the lighting apparatus including: a housing and an electrical contact, the housing comprising: a light source; a motion unit mechanically coupled to the light source; a control unit electrically coupled to the motion unit and the light source and configured to control the motion unit to direct illumination emanating from the light source; and a translucent envelope enclosing the control unit, the motion unit, the light source.

According to further features in preferred embodiments of the invention described below housing further comprises an electro optic unit operationally coupled to the control unit and the light source, the electro optic unit configured to focus the illumination emanating from the light source according to instructions received from the control unit.

According to still further features in the described preferred embodiments the electro optic unit includes a motor for moving a lens closer or further away from the light source.

According to still further features the motion unit includes at least one motor rotationally coupled to the light source, the at least one motor rotates the light source about a first axis.

According to still further features the motion unit includes a second motor, the second motor rotates the light source about a second axis, perpendicular to the first axis. Wherein the first axis is a longitudinal axis or a latitudinal axis.

According to still further features the motion unit is adapted to rotate approximately 360 degrees about the longitudinal axis and approximately 180 degrees about the latitudinal axis.

According to still further features the apparatus further includes a heat sink interposed between the translucent envelope and the electrical contact.

According to still further features the light source includes a light emitting diode (LED) or a plurality of LEDs.

According to still further features the control unit includes a processing unit and one of: a wireless receiver and a wireless transceiver.

According to still further features the motion unit includes reflective surfaces for directing the illumination emanating from the light source.

According to still further features the processing unit is adapted to receive instructions from a wireless device via the wireless receiver and accordingly control the motion unit, and the light source so as to direct illumination emanating from the light source.

According to another embodiment there is provided a lighting apparatus, including: a housing and an electrical contact, the housing including: a light source; a control unit electrically coupled to the light source; an electro optic unit operationally coupled to the control unit and the light source, the electro optic unit configured to focus illumination emanating from the light source according to instructions received from the control unit; and a translucent envelope enclosing the control unit, the light source and the electro optic unit.

According to still further features the housing further includes a motion unit mechanically coupled to the light source and electrically coupled to the control unit, the motion unit includes at least one motor rotationally coupled to the light source, the at least one motor rotates the light source about a first axis.

According to still further features the first axis is a longitudinal axis or a latitudinal axis.

According to still further features the motion unit includes a second motor, the second motor rotates the light source about a second axis, perpendicular to the first axis.

According to still further features the electro optic unit includes a motion actuator for reversibly moving a lens closer to the light source.

According to another embodiment there is provided a lighting apparatus, including: a housing and an electrical contact, the housing including: a plurality of light sources arranged to provide omni-directional illumination; a control unit electrically coupled to the plurality of light sources and configured to selectively control illumination of each of the plurality of light sources; and a translucent envelope enclosing the control unit and the plurality of light sources.

According to still further features the housing further includes a cylindrical central rod upon which the plurality of light sources are mounted.

The present invention discloses an innovative, remotely controlled lighting apparatus such as an LED light bulb where the direction of the illumination and/or the zoom or focus of the light beam can be effected and controlled remotely. One of the unique factors being that the innovative device has the form factor of a regular household light bulb. All the moving parts, mechanical parts and electronic parts are disposed inside the light housing, as opposed to moving a static lamp around.

### BRIEF DESCRIPTION OF THE DRAWINGS

Various embodiments are herein described, by way of example only, with reference to the accompanying drawings, wherein:

FIG. 1 is a first configuration of an innovative lighting apparatus of the immediate invention;

FIG. 2 is a second configuration of an innovative lighting apparatus of the immediate invention;

FIG. 3 is a high level block diagram of the flow operation of the immediate innovative apparatus;

FIG. 4 is a simplified diagram indicating an exemplary lighting configuration that can be effected by the innovative lighting apparatus;

FIG. 5 is a simplified diagram indicating an exemplary lighting configuration that can be effected by the innovative lighting apparatus;

FIG. 6A-C depict other configurations of the innovative lighting apparatus.

### DESCRIPTION OF THE PREFERRED EMBODIMENTS

Apart from the novelty uses of this light bulb, an even more important issue arises as a result of using such bulbs—energy saving. There are many cases in which a person does not need the entire room to be illuminated but rather just a small area or part of the room. Instead of wasting energy lighting the entire room, one can direct the light to the location it is really needed and reduce the amount of energy by 50% or more by reducing the light intensity accordingly.

The principles and operation of a remotely controlled LED light bulb with direct-able light and focus-able light according to the present invention may be better understood with reference to the drawings and the accompanying description.

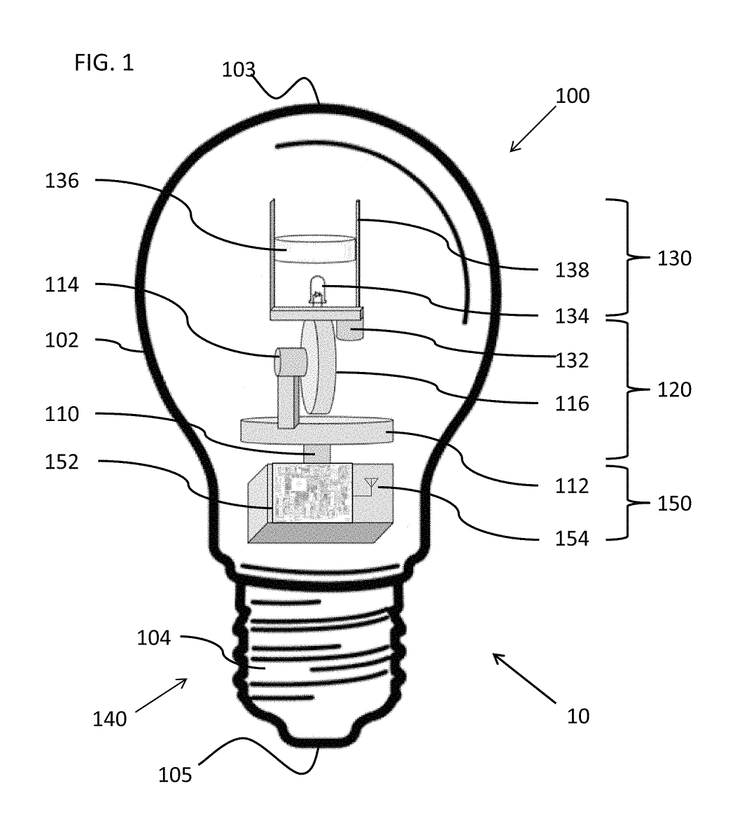

Referring now to the drawings, FIG. 1 illustrates a simplified schematic diagram of the mechanical construction of the innovative light bulb. According to the preferred embodiment in the illustration, an innovative light bulb 10 has the form factor of, or similar to, a regular household light bulb, such as a conventional incandescent light bulb or LED light bulb. Lighting apparatus 10, in preferred embodiments, includes a housing 100 and an electrical contact 140. The simplified schematic illustration of FIG. 1 depicts a translucent envelope 102 and a screw thread contact 104, having the same form factor as a transparent incandescent lightbulb. The translucent envelope encloses the functional components, which are detailed below.

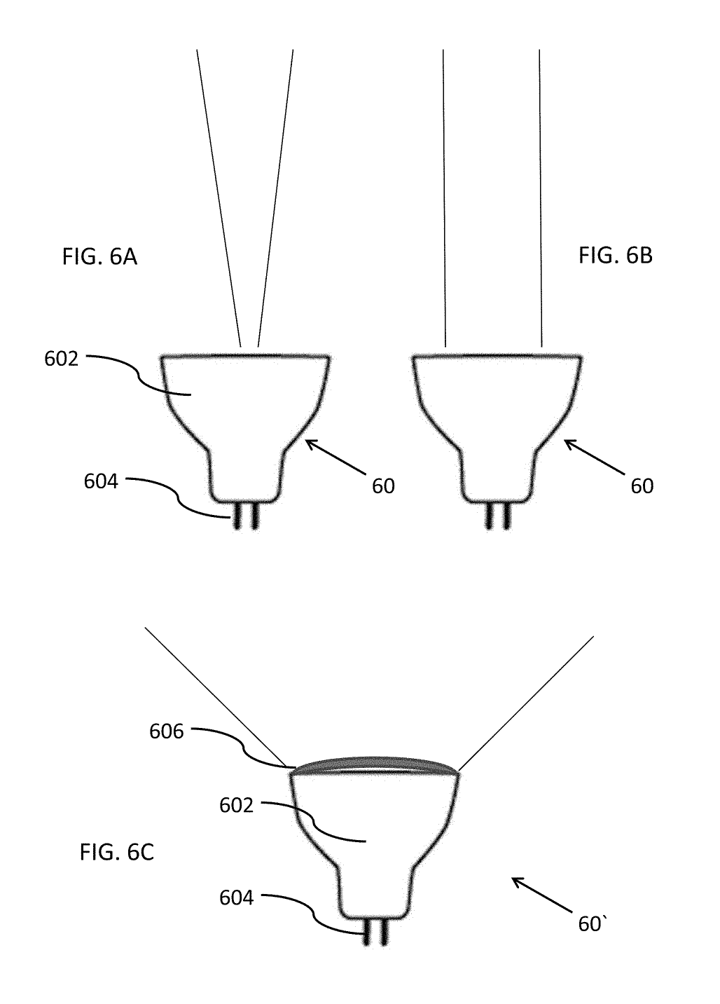

The function of the screw thread contact 104 is for establishing an electrical connection with a source of electrical power via a complementary socket (not shown). Other configurations may be used in which the threaded screw contact 104 may be replaced by any other type of suitable connector for engaging the light bulb within a socket, e.g. a bayonet mount, GU-5.3 pins (see FIGS. 6A-C), GU-10 pins, etc. In some embodiments, additional control signals may be electrically conveyed through a specialized socket to the contact. For example, a wall mounted controller may be wiredly coupled to the specialized socket so as to control the functioning of the innovative lighting apparatus with respect to intensity, coloring, directionality and focus.

There are a great deal of light bulb designs but they all generally follow the same basic form of a globe (or shaped sphere) made of clear, colored and/or semi-opaque glass (or a polymer with similar attributes) and a screw thread contact. While the simplified schematic illustration depicts a globe 102 and a screw thread contact 104, having the same form factor as a transparent incandescent light bulb, it is the express intent of the authors to include within the scope of the invention all shapes, designs and form factors of LED lights for household use. As such, while the word ‘bulb’ may denote a particular shape, it is made clear that the use of the word is to be interpreted widely to include all the different shapes and designed known in the art.

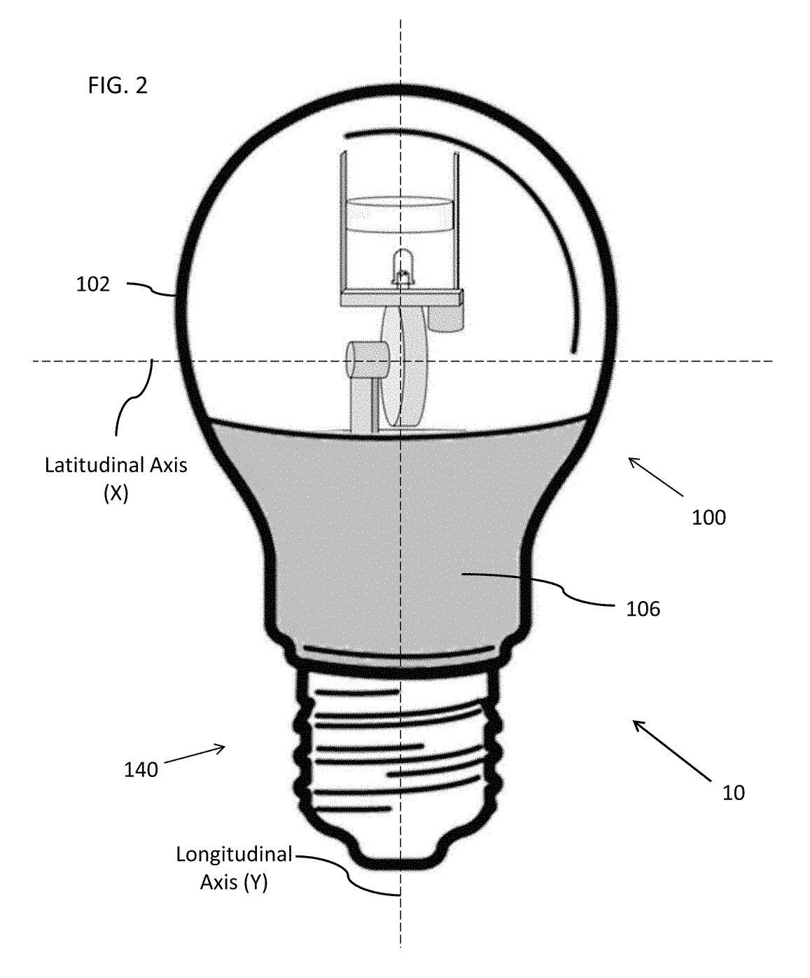

The housing 100 may include a transparent, translucent and/or partially opaque envelope 102 and may be made of glass or any other material suitable for such an envelope, including plastic, and may be of any suitable shape. For example, the transparent/translucent part may only be in the form of a dome while the section between the dome and the screw thread may be opaque (e.g. including a heat sink, see for example FIG. 2).

With regards to the direction of illumination of light, there are, in general, two types of light fixtures, directed and omni-directional lighting. By referring to the device as a light bulb, the connotation is that the illumination is, at least, omni-directional. This is the case with a transparent envelope (e.g. of an incandescent light bulb). This is also the case when the light source is somewhat directional (as is the case with LED light sources), but the light is diffused by the rounded sphere or dome which is semi-transparent or translucent (e.g. frosted) and therefore reflectively diffuses the light which results in the even quality and the omni-directionality of the light.

Omni-directional light, as is generally understood and as is specifically intended herein, refers to illumination which extends outwards from the lamp in 360 degrees around the lamp/light bulb. For the sake of clarity the light bulb serves as a central axis from which the light emanates at least in a 360 degree radius around the light bulb. Light also emanates out of the top of the globe and also illuminates, to a much smaller degree, below the screw contact. Generally, light fixtures are suspended from the ceiling or mounted on a wall. Therefore, omni-directional illumination, at least for the purposes of the present invention, refers to 360 degree illumination about the longitudinal axis (Y) and an arc defining 180 degrees illumination about the latitudinal axis defined by the tilt motor.

FIG. 2 illustrates another embodiment of the lighting apparatus whereby part of the envelope is opaque. With regards to the embodiments of both FIG. 1 and FIG. 2, the central axis of the light bulb is a longitudinal axis (Y) that traverses the extreme exposed (lowest) point 105 of the contact at the ‘bottom’ of the screw thread and the apex 103 of the dome of the glass bulb (or translucent envelope). The light radiates out in all directions that are not shuttered or covered, as dictated by the width of the illumination beam and/or the direction in which the light source is directed.

The embodiments of FIG. 1 and FIG. 2 are similar in all respects, except that in the depicted embodiment of FIG. 2, an opaque segment 106 is provided between the translucent dome and the screw thread contact. Segment 106 may be a heat sink and/or holder for wiring and electronic components such as a control unit and at least part of a motion unit.

With regards to the configuration of the light bulb that includes an opaque segment 106 and only a dome of translucent material 102 (FIG. 2), the opaque segment may prevent the illumination of an arc of 180 about the tilt motor. In the depicted configuration of FIG. 2, the axis running through the center of the tilt motor (latitudinal axis X) is above the opaque area of the housing. In other embodiments, the longitudinal axis may be in line with the top edge of the opaque area 106. In still other embodiments, the longitudinal axis may be below the top edge of the opaque area 106, and as a result, the arc of tilt of the light source may be less than 180 degrees.

The present innovation provides the added functionality of directionality and focus to the known functions of an LED light bulb by controlling the movement and/or focus of the light source or by partially shuttering the bulb so as to emit illumination only in the desired direction and/or focus.

Referring to both FIG. 1 and FIG. 2, inside the form factor of the light bulb resides a control unit 150 of the system. The control unit 150 includes the electrical circuitry as well as the electronic components for controlling the mechanical mechanisms responsible for providing the aforementioned functionality and communicating with remote control devices (either wireless or wired). Control unit 150 includes at least a microprocessor unit 152 and wireless receiver or transceiver 154. The control unit 150 is discussed in greater detail below.

Included within housing 100 is the aforementioned control unit 150, as well as a light source and a motion unit for moving the light source. The translucent envelope 102 encloses the control unit, light source and motion unit within the housing. In preferred embodiments, the housing 100 further includes an electro optic unit for narrowing and widening the illumination from the light source. The embodiments depicted in the figures include both a motion unit and an electro optic unit, however it is made clear that the either the motion unit or the electro optic unit may not be included within the housing 100.

Specifically, in another configuration, the housing includes a control unit, a light source and an electro optic unit. The focus of the beam may be broadened or narrowed by the electro optic unit, without being able to move the light source. However, as mentioned above and depicted in the figures, in preferred embodiments, the housing further includes a motion unit 120.

Within the lighting apparatus 10 are found connecting wires for providing electrical power to a microcontroller/microprocessor 152, receiver 154, motion actuators (e.g. three servo motors that rotate, tilt and zoom the lighting source) 120/130 and a lighting source 134.

In the depicted embodiment the lighting source is a single LED element 134. It is however made clear that a single lighting source is merely exemplary and the lighting source may alternatively be comprised of multiple LED light components. While the present document will describe embodiments in which the lighting source 134 is an LED light component, it is to be understood that other light types may also be used in alternate implementations.

While it is clear that the innovative circuitry and components can be implemented in a multitude of configurations, only a small number of preferred embodiments are discussed herein. It is made clear that the preferred embodiments are merely exemplary and not intended to be limiting in any way. The exemplary embodiments of the electronic components are discussed in greater detail below.

In one preferred embodiment, the motion unit includes a tilt motor 114, mechanically connected to the light source 134. The center of the tilt motor defines a latitudinal axis X. The tilt motor 114 moves the light source in an arc about the latitudinal axis X.

In preferred embodiments, the motion unit 120 alternatively or additionally includes a rotational motor 110. The center of the rotational motor defines a longitudinal axis Y. In one preferred embodiment, the rotational motor 100 is directly coupled to, and rotates, the light source 134 about the Y axis.

In another preferred embodiment, the motion unit includes a rotational motor 110 that is coupled to a tilt motor 114 which is coupled to the light source. The motion unit can move the light source about both axes X and Y.

The motion unit includes at least one motion actuator rotationally coupled to the light source, the at least one motor rotates the light source about a first axis. The motion unit includes a second motion actuator, that rotates the light source about a second axis, perpendicular to the first axis. The first axis is a longitudinal axis or a latitudinal axis.

On command from the control unit 150, a rotation servo 110 rotates the light source about the Y-axis, in either a left or right direction. In preferred embodiments the light source is rotated approximately 360 degrees about the Y axis. The rotation servo 110 is mechanically coupled to a mechanical base 112. Base 112 supports the remaining electro-mechanical components that rotate the light source about the Y-axis (longitudinal axis) when base 112 is rotated by rotation servo 110.

A tilt motor 114 is mechanically coupled to base 112. The tilt motor 114 is responsible for a tilt motion of a light mechanical base 116 about an X-axis (latitudinal axis). The arc of the tilt may be about 180 degrees. In some embodiments the arc is greater than 180. In some embodiments the arc is precisely 180 degrees. In some embodiments the arc is smaller than 180 degrees. Any and/or all of the motors mentioned herein may be electric motors, e.g. stepping motors, servo motors or any other type of motion device such as, but not limited to, linear actuators, pneumatic or hydraulic drives, magnets or any other controlled device that causes the required movement of the light source.

In preferred embodiments, the housing further includes an electro optic system 130. The electro optic system 130 is preferably installed on the light mechanical base. In preferred embodiments the electro-optic system includes a motor 132, an LED light source/sources 134 and an optical lens/lenses 136. The optical lens/lenses are held by a lens mechanical holder 138 and moved closer or farther away from the light source by a linear mechanical motion driven by the motion actuator/motor 132. Moving the lens (or lenses) closer or further away from the light source (and/or from each when more than one lens is used) either narrows or widens the beam of illumination emanating from the light source, depending on the type (or types) of lens (or lenses) used.

The microcontroller 152 comprises hardware and/or firmware storing instructions (computer-readable, machine-readable instructions, software) for controlling operations of the motion system 120, the electro optic system 130 and the lighting source 134. In a non-limiting implementation, the instructions stored on the hardware and/or firmware may control the color and/or intensity of the light that is generated by the lighting apparatus 10. Additionally or alternatively, the instructions stored on the hardware and/or firmware may control the manner in which the lighting apparatus 10 operates, for example by providing features such as dimming functionality and special lighting effects and/or lighting patterns for example.

In a non-limiting implementation, the instructions stored on the hardware and/or firmware may control the rotation and tilt of the light source and/or reflective members as actuated to the motion system 120 of the lighting apparatus 10. In a non-limiting implementation, the instructions stored on the hardware and/or firmware may control the focus or spread of the illumination radiating from the light source as affected by the electro optic system 130 of the lighting apparatus 10.

The control unit 150 includes components responsive to a signal received over a wireless communication link from an auxiliary device (e.g. smartphone, dedicated remote controller) external to the innovative lighting apparatus 10. Namely, control unit 150, includes a wireless receiver 154. Alternatively, the innovative lighting apparatus 10 may receive the signal over a wired connection from a fixed control panel mounted nearby. The wired or wireless signal may contain instructions which are encoded into the signal and instruct the control unit as to what changes in the lighting apparatus must be effected.

Wireless receivers are known in the art. The wireless receiver may be a transceiver that is able to transmit signals as well as receive signals. The wireless receiver/transceiver may be a Wi-Fi transceiver which is technology for wireless local area networking with devices based on the IEEE 802.11 standards. Alternatively or additionally the receiver/transceiver may be a Bluetooth™ (BLUETOOTH is a registered trademark of the Bluetooth Special Interest Group) transceiver. Additionally or alternatively, the transceiver may be a cellular transceiver capable of receiving signals over the mobile cellular network.

In preferred embodiments, the innovative lighting apparatus 10 has network connectivity via the (wired or) wireless transceiver 154. Further, the apparatus has a MAC identifier and a network address. As such, the device can be accessed remotely, e.g. via the Internet. As such, the functionality of the lighting apparatus can be controlled, even when not in the immediate area of the device. In some embodiments, this functionality is in addition to the functionality that is based on immediate area wireless communication such as Bluetooth. It is made clear that Bluetooth and Wi-Fi are merely exemplary types of wireless communication, and that are types of wireless communication known in the art are included within the scope of the invention.

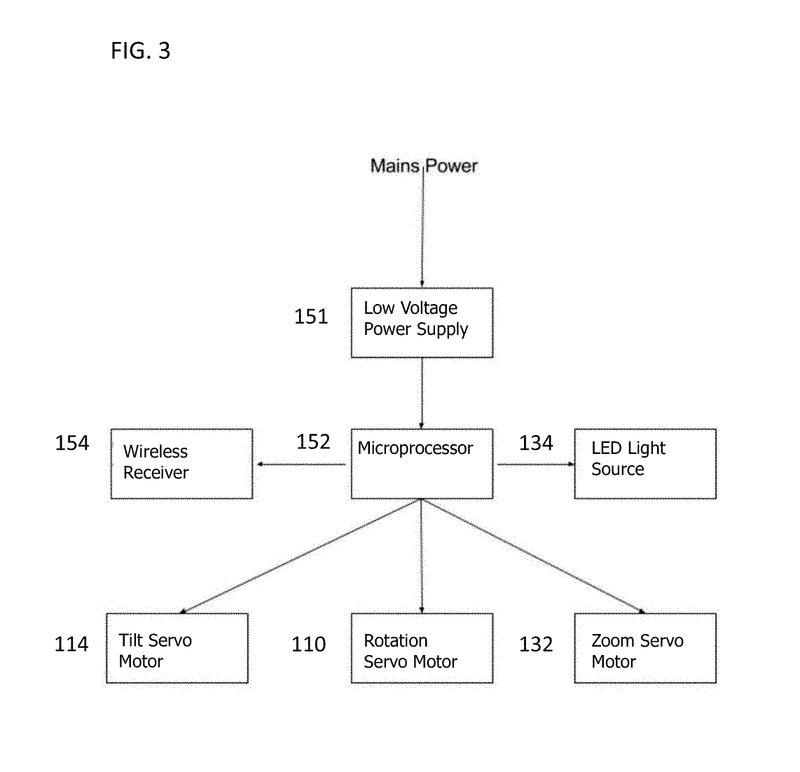

FIGS. 1 and 2 depict embodiments of the present innovative apparatus within the form factor of a common incandescent bulb or LED bulb. FIG. 3 is a high level block diagram of the flow operation of the immediate innovative apparatus. High voltage coming from the power mains is converted using the low voltage power supply 151 into a voltage suitable for the control unit 150. The microprocessor 152 is responsible for the general operation of the system which includes, but is not limited to: controlling the on/off state, intensity and color of the LED light source 134, communicating with a computing device (e.g. personal computer, laptop computer, tablet computer etc.), fixed control panel, Smartphone, etc. using the WiFi/Bluetooth (wireless) transceiver 154 and controlling the tilt, rotation and zoom/focus of the three servo motors (motion actuators).

Rotation of the light source is achieved by the rotation servo 110 which rotates the light source approximately 360 degrees about the longitudinal or Y axis. The tilt motor servo 114 tilts the light source in an arc defining about 180 degrees. The zoom servo 132 narrows and broadens the beam of light radiating from the light source 134, e.g. by moving the lens closed or further away from the light source.

The embodiments depicted in the figures include a light source, lens and motors for rotating the light source and focusing the beam of illumination. However, in some configurations it may be easier to direct the beam onto a reflector and move the reflector to change the direction of the beam. This type of reflector is well known in the field of theatre and dance lighting as well as laser direction in the field of military devices. Any other means that effects the required alteration in the direction of the beam may also be used.

The mirror can be moved by electric motors, e.g. stepping motors, or by linear actuators, pneumatic or hydraulic drives or by magnets or by any other controlled device that causes the required movement of the mirrors. Furthermore, if cost effective, micro-electro-mechanical systems (MEMS) can be employed to control movement of the mirrors (and/or the light source discussed above). MEMS refers to the technology of microscopic devices, particularly those with moving parts.

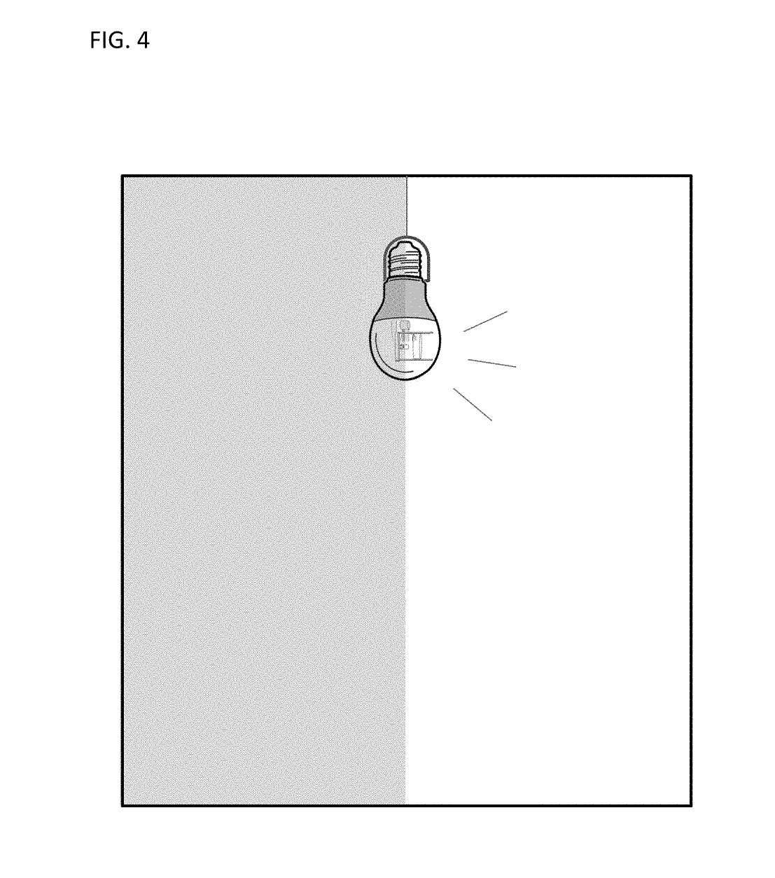

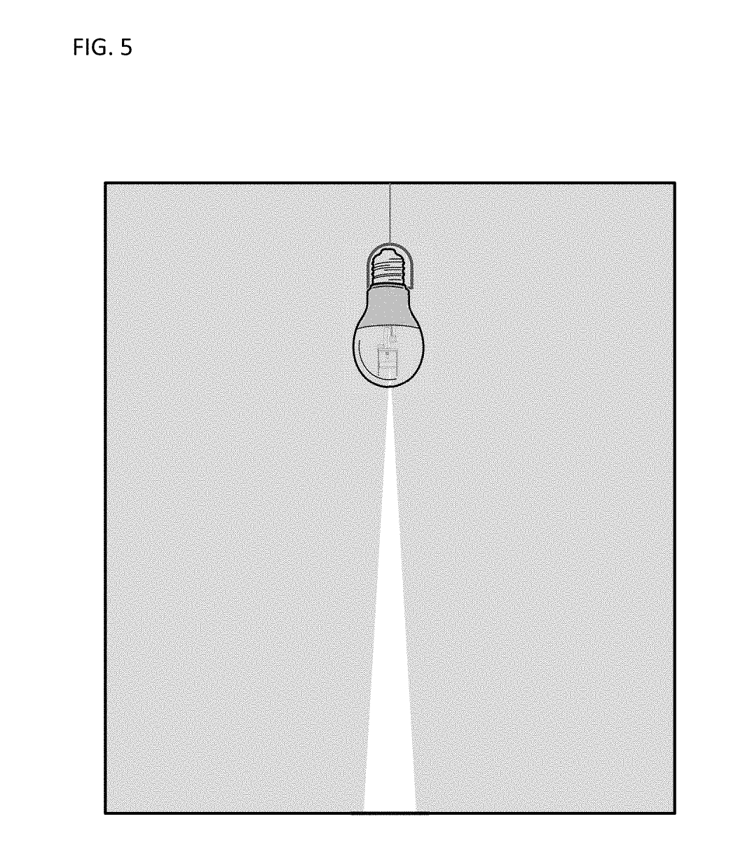

FIGS. 4 and 5 are simplified diagrams indicating exemplary lighting configurations that can be effected by the innovative lighting apparatus 10. In FIG. 4 there is depicted a simplified room with an innovative lighting apparatus of the immediate innovation installed in an standard light socket suspended from the roof. The apparatus is providing illumination for half of the room while the other half of the room is left in darkness. This is of course a simplified depiction intended to illustrate the one lighting configuration possible, without taking into consideration the effects ambient light has on the entire space. The intention of the illustration is to show illumination when the light source is rotated and tilted to direct the illumination to one side of the room and the focus of the beam is wide to disperse the light to encompass about half of the room.

FIG. 5 depicted another configuration of illumination, where the light source is rotated and tilted to a specific position and the beam of illumination is very narrow. The LED light is conventionally a ‘directed light’ source. The lens (or system of lenses) is moved closer or further away from the light source by the linear actuator 132, spreading or focusing the beam as desired.

It is made clear that other arrangements of mechanical and/or electro-optical mechanisms can be employed to provide either the movement of the light source or the widening and narrowing of the illumination beam or both. It is further made clear that the use of mechanically driven shutters can be arranged to provide all or much of the aforementioned functionality. It is still further made clear that the use of mirrors and optoelectronic mechanisms can be employed to provide the aforementioned control over movement and or illumination.

Another possible configuration is shown in FIGS. 6A-6C. In FIG. 6A, depicts a lighting apparatus 60. The lighting apparatus 60 has the form factor of a conventional LED spot lamp 602, usually used for specialized indoor focus lighting the like. Here the electrical contacts 604 are two pins/prongs for electrically coupling the apparatus to a socket with corresponding apertures. Innovatively, the lighting apparatus 60 focuses or widens the illumination beam in any one of the manners discussed above. Specifically, for example, a lighting source (not shown) may be covered with an optical element such as a lens (see FIG. 6C). The lens is moved closer or further away from the light source depending on whether a wider or narrower beam is desired. Conversely, the lens may be fixed while the light source moves towards or away from the lens. Alternatively, a reflective surface or surfaces may be used to focus and/or direct the light beam. Further alternatively the light source may have a non-conventional configuration as is discussed in further detail below.

As above, the functioning of the apparatus is controlled remotely, either by wired or wireless means. The discussions relating to the control means, mechanical means, electro optical means and other parts relevant here are understood to be included within the scope of the innovation as relates, mutatis mutandis to the instant configuration.

It is however clear that the potential field of illumination is more limited with the instant configuration, due to the lack of dome or globe within which to rotate the light source about a latitudinal axis. As such, The illumination beam of FIG. 6A is generally projected in the direction opposite the contacts 604 end. The illumination beam is a narrow beam. The beam may emanate directly from one or more LED light sources. Alternatively, the beam may be reflected off a mirror or mirrors as discussed elsewhere herein.

Furthermore, while LED devices are commonly regarded as directional light sources (that is the premise elsewhere in this document), LEDs are not inherently directional light sources. Since early LEDs were developed for indicator applications, the most efficient optical design for this purpose was to use the familiar epoxy capsule, which focuses light forward. However, there is nothing inherent in this degree of directionality for LED devices. An LED semiconducting element can potentially emit light in many directions, and many illumination-grade LEDs have fairly broad distribution. Note that the opacity of heat sinking materials in some LED systems can limit the resulting distribution of light, as in the instant configuration as well as the configuration depicted in FIG. 2. The widening beam of FIG. 6A may therefore be the result of the light being focused by a lens or reflected by a mirror or due to the configuration of the LED light source itself.

FIG. 6B illustrates a directional beam that does not expand outwards. Once again, the directionality of the beam may be due to the configuration of the LED light source or sources, or due to passing through a focus lens, or due to the use of reflective surfaces or a combination of thereof. FIG. 6C illustrates a lighting apparatus 60′ which is similar to lighting apparatus 60, with the addition of a slightly convex, or domed cover 606. The covering 606 may be transparent or translucent (e.g. fogged). The domed cover may be an optical lens. The lighting apparatus 60′ generates a wide, outwardly expanding beam. The instant beam type illustrates a potential limitation of the instant configuration and those of the other spot lamp (depicted in FIGS. 6A and 6B). That is to say that the lack of space between the heatsink 602 and the dome 606 (or flat cover as in FIGS. 6A and 6B) limits the angle of illumination to the spread depicted in FIG. 6C or thereabouts.

Yet another configuration is envisioned whereby a lighting apparatus has the form factor of an incandescent bulb or that of an LED bulb or thereabouts (e.g. similar to FIG. 1 or 2). However, in contrast to the configurations discussed above, in the present embodiment, a plurality of light sources are mounted within the transparent envelope, facing different directions to provide omni-directional illumination. In one embodiment, an array of light emitting elements (e.g. LEDs) is mounted on a central cylindrical rod facing outwards. The light emitting elements are fixedly positioned on the central rod to provide illumination spanning 360 degrees outwards from a vertical axis defined by the central rod. In preferred embodiments, the light emitting elements are also arranged in an arc spanning about 180 degrees or more, e.g. following the arc of the dome of the translucent envelope.

In other embodiments, the light emitting elements may be mounted on the inside of the translucent envelope. Preferably the elements are arranged about 360 degrees about a longitudinal axis X as discussed above. In further preferred embodiments the light emitting elements are mounted in the arc of the dome of the lighting apparatus, spanning about 180 degrees.

In the aforementioned embodiments, the light emitting elements are electrically coupled to a control unit, housed within the housing of the lighting element. The control unit is the same or similar to the control unit discussed above. The housing and electrical contact are the same or similar to those discussed above. The control unit receives instructions from a remote device. The remote device is either wired or wirelessly in communication with the lighting apparatus.

The array of light sources (mounted on the central rod or the inside of the translucent envelop) are controlled by the microprocessor in the control unit. A user is able to individually control each of the lighting elements (or groups of lighting elements) so that only a particular angle of the light bulb will emit light while the other angles remain dark and achieve the same purpose as the other apparatuses and methods described elsewhere in this document.

It is made clear that any element, component, configuration, function or structure that is discussed with relation to a particular embodiment is intended, where relevant, to apply to all the other embodiments disclosed herein.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A remotely controlled lighting apparatus, the lighting apparatus comprising:
a housing and an electrical contact, said housing comprising:
a light source;
a motion unit mechanically coupled to said light source;
a control unit electrically coupled to said motion unit and said light source and configured to control said motion unit to direct illumination emanating from said light source; and
a translucent envelope enclosing said control unit, said motion unit, said light source.

2. The lighting apparatus of claim 1, wherein said housing further comprises an electro optic unit operationally coupled to said control unit and said light source, said electro optic unit configured to focus said illumination emanating from said light source according to instructions received from said control unit.

3. The lighting apparatus of claim 2, wherein said electro optic unit includes a motor for moving a lens closer or further away from said light source.

4. The lighting apparatus of claim 1, wherein said motion unit includes at least one motor rotationally coupled to said light source, said at least one motor rotates said light source about a first axis.

5. The lighting apparatus of claim 4, wherein said motion unit includes a second motor, said second motor rotates said light source about a second axis, perpendicular to said first axis.

6. The lighting apparatus of claim 4, wherein said first axis is a longitudinal axis or a latitudinal axis.

7. The lighting apparatus of claim 6, wherein said motion unit is adapted to rotate approximately 360 degrees about said longitudinal axis and approximately 180 degrees about said latitudinal axis.

8. The lighting apparatus of claim 1, further comprising a heat sink interposed between said translucent envelope and said electrical contact.

9. The lighting apparatus of claim 1, wherein said light source includes a light emitting diode (LED).

10. The lighting apparatus of claim 1, wherein said light source includes a plurality of LEDs.

11. The lighting apparatus of claim 1, wherein said control unit includes a processing unit and one of: a wireless receiver and a wireless transceiver.

12. The lighting apparatus of claim 1, wherein said motion unit includes reflective surfaces for directing said illumination emanating from said light source.

13. The lighting apparatus of claim 11, wherein said processing unit is adapted to receive instructions from a wireless device via said wireless receiver and accordingly control said motion unit, and said light source so as to direct illumination emanating from said light source.

14. A lighting apparatus, comprising:
a housing and an electrical contact, the housing comprising:
a light source;
a control unit electrically coupled to said light source;
an electro optic unit operationally coupled to said control unit and said light source, said electro optic unit configured to focus illumination emanating from said light source according to instructions received from said control unit; and
a translucent envelope enclosing said control unit, said light source and said electro optic unit.

15. The lighting apparatus of claim 14, wherein said housing further comprises a motion unit mechanically coupled to said light source and electrically coupled to said control unit, said motion unit includes at least one motor rotationally coupled to said light source, said at least one motor rotates said light source about a first axis.

16. The lighting apparatus of claim 15, wherein said first axis is a longitudinal axis or a latitudinal axis.

17. The lighting apparatus of claim 16, wherein said motion unit includes a second motion actuator, said second motion actuator rotates said light source about a second axis, perpendicular to said first axis.

18. The lighting apparatus of claim 14, wherein said electro optic unit includes a motion actuator for reversibly moving a lens closer to said light source.

19. A lighting apparatus, comprising:
a housing and an electrical contact, the housing comprising:
a plurality of light sources arranged to provide omni-directional illumination;
a control unit electrically coupled to said plurality of light sources and configured to selectively control illumination of each of said plurality of light sources; and
a translucent envelope enclosing said control unit and said plurality of light sources.

20. The lighting apparatus of claim 19, wherein said housing further comprises a cylindrical central rod upon which said plurality of light sources are mounted.
